(19) United States
(12) Patent Application Publication
(10) Pub. No.: US 2017/0183547 A1
(43) Pub. Date: Jun. 29, 2017

(54) Composition for Preparing Pressure-Sensitive Adhesives

(71) Applicant: TESA SE, Norderstedt (DE)

(72) Inventors: Sarah Bamberg, Hamburg (DE); Julia BEFUSS, Norderstedt (DE); Benjamin PUETZ, Hamburg (DE); Alexander PRENZEL, Hamburg (DE)

(21) Appl. No.: 15/359,908

(22) Filed: Nov. 23, 2016

(30) Foreign Application Priority Data
Dec. 9, 2015 (DE) 10 2015 224 734.1

(51) Int. Cl. C09J 133/08

(52) U.S. Cl. CPC C09J 133/08; C08K 5/544

(57) ABSTRACT

The intention is to provide a thermally crosslinkable, polyacrylate-based composition which can be processed from the melt and is distinguished by long pot life and by rapid and complete or near-complete crosslinkability even at relatively low temperatures, which can be processed to a pressure-sensitive adhesive. This aim is accomplished with a composition which comprises
a) at least one crosslinkable poly(meth)acrylate;
b) at least one organosilane conforming to the formula (1)

R¹—Si(OR²)ₙR³ₘ (1),
in which R¹ is a radical containing a cyclic ether function,
the radicals R² independently of one another are each an alkyl or acyl radical,
R³ is a hydroxyl group or an alkyl radical,
n is 2 or 3 and m is the number resulting from 3-n; and
c) at least one substance accelerating the reaction of the crosslinkable poly(meth)acrylate with the cyclic ether functions.

The patent application further provides a pressure-sensitive adhesive obtainable from the composition.

The invention relates to the technical field of pressure-sensitive adhesives (PSAs), especially of polyacrylate-based PSAs. Proposed specifically is a crosslinker-accelerator system for such adhesives, this system including as essential constituents an organosilane having a cyclic ether function and at least two water-eliminable groups, and a substance which accelerates the crosslinking reaction.

For high-grade adhesives, PSAs or heat-sealing compounds in industrial applications the use of polyacrylates is frequent, on account of their having emerged as highly suitable for the growing requirements in these fields of application. PSAs accordingly are required to exhibit good tack, but also to meet exacting requirements in terms of shear strength, particularly at high temperatures and also under high atmospheric humidity and/or in contact with moisture. At the same time the compositions must also have good processing qualities, and in particular must be suitable for coating onto carrier materials. This is achieved, for example, through the use of polyacrylates with high molecular weight and through efficient crosslinking. Polyacrylates, moreover, can be produced in transparent and weathering-stable forms.

In the coating of polyacrylate compositions from solution or as a dispersion, thermal crosslinking has long been state of the art. In general, the thermal crosslinker—customarily a polyfunctional isocyanate, a metal chelate or a polyfunctional epoxide—is added to the solution of a poly(meth)acrylate equipped accordingly with functional groups, the resulting composition is coated as a sheetlike film onto a substrate, using a doctor blade or coating bar, and the coating is subsequently dried. Through this procedure, diluents—that is, organic solvents or water in the case of the dispersions—are evaporated and the polyacrylate is crosslinked accordingly. Crosslinking is very important for the coatings, endowing them with sufficient cohesion and thermal shear strength. Without crosslinking, the coatings will be too soft and would flow away even under a low load. Critical to a good coating outcome is the observance of the pot life. This is the time within which the system is in a processable state. The pot life may differ significantly according to the crosslinking system. If it is too short, the crosslinker has already undergone reaction in the polyacrylate solution; the solution is already partly crosslinked (or gelled) and can no longer be applied as a uniform coating.

For reasons of environmental protection, in particular, the technological process for preparing PSAs has undergone continual onward development. Motivated by more restrictive environmental impositions and by rising prices for solvents, an aim is to eliminate the solvents as far as possible from the manufacturing operation for adhesives and adhesive tapes. Within the industry, therefore, melting processes (also referred to as hot melt processes) with solvent-free coating technology are of growing importance in the production of adhesive products, more particularly of PSAs. In these processes, meltable polymer compositions, i.e. polymer compositions which enter the fluid state without crosslinking at elevated temperatures, are processed. Such compositions can be processed outstandingly from this melt state. In onward developments of the process, production may also be carried out in a low-solvent or solvent-free procedure.

The introduction of the hot melt technology is imposing growing requirements on the adhesives. Meltable polyacrylate compositions in particular (alternative designations: “polyacrylate hot melts”, “acrylate hot melts”) are being investigated very intensely for improvements. In the coating of polyacrylate compositions from the melt, thermal crosslinking has to date not been very widespread, in spite of the advantages of this method.

Acrylate hot melts have to date been crosslinked primarily through radiation-chemical processes (UV irradiation, EBC irradiation). This procedure, however, is associated with a variety of disadvantages:
In the case of crosslinking by means of UV rays, only UV-transparent layers can be crosslinked.
In the case of crosslinking with electron beams (electron beam crosslinking or electron beam curing, also EBC), the electron beams possess only limited depth of penetration, dependent on the density of the irradiated material and on the accelerator voltage.
In both of the aforementioned methods, the layers after crosslinking have a crosslinking profile; the PSA layer does not crosslink homogeneously.

The PSA layer must be relatively thin so that well-crosslinked layers are obtained. The thickness through which radiation can pass, though indeed varying as a function of density, fillers, accelerator voltage (EBC) and active wavelength (UV), is always greatly limited; accordingly, it is not possible to effect crosslinking through layers of arbitrary thickness or layers with high filler fractions, and certainly not homogeneously.

There are a number of methods known in the prior art for the thermal crosslinking of acrylate hot melts. In each of these methods a crosslinker is added to the acrylate melt prior to coating, and the composition is then shaped and wound to form a roll.

DE 10 2004 044 086 A1 describes a method for thermally crosslinking acrylate hot melts wherein a solvent-free, functionalized acrylate copolymer, which, after addition of a thermally reactive crosslinker, has a processing life which is long enough for compounding, conveying and coating, is applied to a web-form layer of a further material. After coating has taken place, the material subsequently crosslinks under mild conditions, until cohesion sufficient for PSA tapes is achieved.

A disadvantage of this method is that the free processing life and the degree of crosslinking are predetermined by the reactivity of the crosslinker. If isocyanates are used, they react in some cases even on addition, meaning that the gel-free time may be very short, depending on the system. A composition having a relatively high proportion of functional groups such as hydroxyl groups or carboxylic acid groups can then no longer be applied in sufficient quality. A streaky coat interspersed with gel specks and therefore inhomogeneous would be the consequence.

Another problem which arises is that the achievable degree of crosslinking is limited. If a higher degree of crosslinking is desired through addition of a higher quantity of crosslinker, this has disadvantages when using polyfunctional isocyanates. The composition would react too quickly and would be able to be applied—if at all—only with very low processing life and hence very high process speed, which would exacerbate the problem of the inhomogeneous coating pattern.

EP 1 317 499 A describes a method for crosslinking polyacrylates via a UV-initiated epoxide crosslinking, in which the polyacrylates were functionalized with corresponding groups during the polymerization. The method offers advantages in terms of the shear strength of the crosslinked polyacrylates relative to conventional crosslinking mechanisms, especially to electron beam crosslinking. In this specification, the use is described of di- or polyfunctional oxygen-containing compounds, more particularly of di- or polyfunctional epoxides or alcohols, as crosslinking reagents for functionalized polyacrylates, more particularly functionalized acrylate hot melt PSAs.

Since the crosslinking is initiated by UV rays, the disadvantages already identified come about here as well.

EP 1 978 069 A1, EP 2 186 869 A1 and EP 2 192 148 A1 disclose crosslinker-accelerator systems for the thermal crosslinking of polyacrylates, which comprise a substance containing epoxide groups or oxetane groups, as crosslinker, and a substance which has an accelerating effect on a linking reaction between the polyacrylates and the epoxide or oxetane groups at a temperature below the melting temperature of the polyacrylate. Examples of accelerators proposed are amines or phosphines. These systems are already highly useful in hot melt processes, but an increase in the crosslinking rate of the polyacrylate after shaping would be desirable. The substances with accelerating effect have been found to be disadvantageous in adhesive bonds under hot and humid conditions, since they may migrate to the substrate and promote the penetration of water between adhesive and substrate.

Another class of crosslinkers, being used more and more on account in particular of the ease of controlling the crosslinking reaction, are alkoxysilanes. WO 2008 116 033 A1 describes acrylate PSAs comprising silyl-functionalized comonomers that can be crosslinked by atmospheric moisture. However, the incorporation of such monomers makes it more difficult to prepare a solvent-free polymer which can also be processed as a hot melt, since a crosslinking reaction may occur as early as during the removal of the solvent and/or during the polymerization.

US 2007/0219285 A1 describes PSAs comprising a mixture of a polyacrylate with silane-terminated oligomers which crosslink by UV-initiated release of a Brønsted acid in the presence of moisture. In spite of stable processing of these adhesive systems, the products have the disadvantage that the acids released may migrate and lead to corrosion or decomposition of the substrate.

UV-initiatable, silane-based crosslinkers are disclosed in U.S. Pat. No. 5,552,451 A1, but they also have the disadvantages denoted above.

DE 10 2013 020 538 A1 discloses a PSA which comprises an organosilane having a glycidyl, glycidyloxy or mercapto group and also an alkoxysilyl end group. The organosilane is not explicitly bound to the PSA.

It is an object of the present invention to enable thermal crosslinking of polyacrylate compositions which can be processed from the melt (“polyacrylate hot melts”) where there is to be a sufficiently long pot life available for the processing from the melt. This is to be the case in particular in comparison with known thermal crosslinking systems for polyacrylate hot melts. Preferably, after the shaping of the polyacrylate composition, a crosslinking reaction at reduced temperatures (for example at room temperature) is to take place which proceeds more rapidly than in the case of the systems known to date. In addition, the products producible accordingly are to have improved stability to heat and humidity and are to have good thermal shear strength, and are also to be amenable to utilization as PSAs—that is, they are to have appropriate technical adhesive properties.

In tandem with all this it is to be possible to do without the use of protective groups, which may have to be removed again by actinic radiation or other methods, and volatile compounds, which remain in the product and cause outgassing. Moreover, the degree of crosslinking of the polyacrylate composition is to be amenable to adjustment to a desired level without detriment to the advantages of the operating regime.

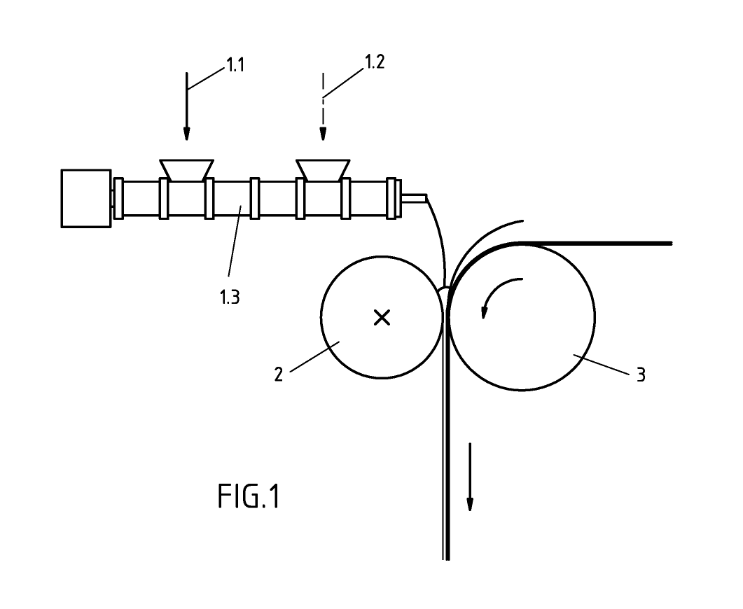

FIG. 1 is a depiction of an apparatus useful in accordance with a process for the production of a pressure sensitive adhesive of the invention which apparatus comprises an extruder, a doctor roll and a coating roll illustrating an example of a process according to the present invention.

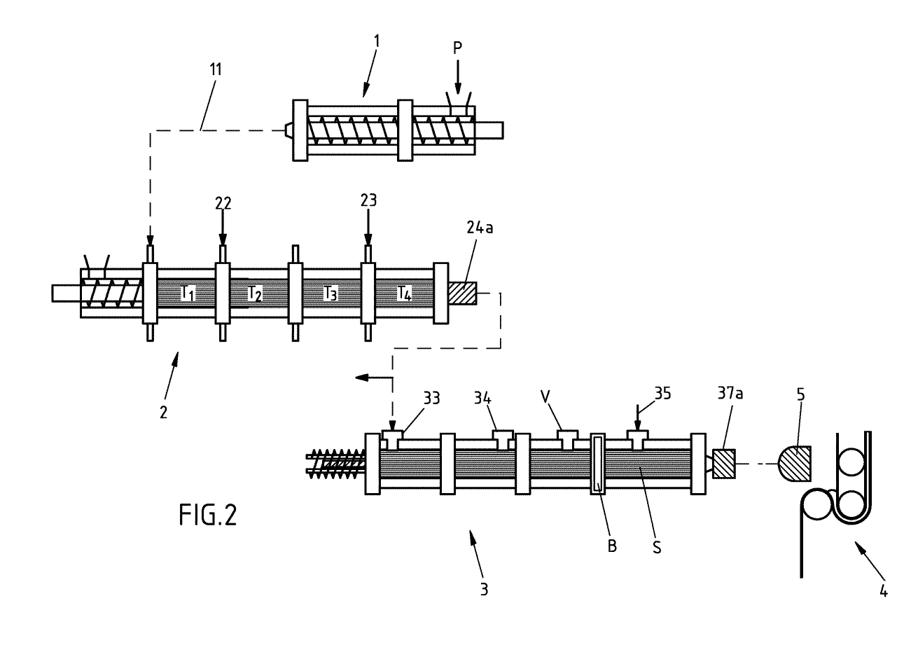

FIG. 2 is a depiction of a further apparatus useful in conjunction with a process for the production of a pressure sensitive adhesive of the invention, which further apparatus comprises a feeder extruder, a planetary roller extruder, a twin screw extruder, a die and a roll calendar.

The achievement of the object is based on the concept of using an organosilane having at least two different functionalities as crosslinker. A first general subject of the invention is a composition for preparing a pressure-sensitive adhesive that comprises

a) at least one crosslinkable poly(meth)acrylate;

b) at least one organosilane conforming to the formula (1)

R¹—Si(OR²)ₙR³ₘ (1),

in which R¹ is a radical containing a cyclic ether function,

the radicals R² independently of one another are each an alkyl or acyl radical,

R³ is a hydroxyl group or an alkyl radical,

n is 2 or 3 and m is the number resulting from 3-n; and

c) at least one substance accelerating the reaction of the crosslinkable poly(meth)acrylate with the cyclic ether functions.

It has emerged that with the crosslinker-accelerator system of the invention, comprising the crosslinker conforming to the formula (1) and also a substance accelerating the crosslinking reaction, the achievements include, in particular, very rapid crosslinking reactions and improved heat-and-humidity robustness on the part of the resultant adhesives. Also surprising in this context was that the composition of the invention required no further addition of water or exposure to atmospheric moisture for the crosslinking via the silyl groups in order to lead, after just a short time, to the desired degree of crosslinking of the product; the residual moisture of the polymer was therefore sufficient for crosslinking. An increase in the atmospheric humidity during storage led to an acceleration of the crosslinking reaction, resulting in a similar level of crosslinking.

A pressure-sensitive adhesive is understood in accordance with the invention, as customary generally, as a material which in particular at room temperature is permanently tacky and also adhesive. Characteristics of a pressure-sensitive adhesive are that it can be applied by pressure to a substrate and remains adhering there, with no further definition of the pressure to be applied or the period of exposure to this pressure. In some cases, depending on the precise nature of the pressure-sensitive adhesive, the temperature, the atmospheric humidity, and the substrate, exposure to a minimal pressure of short duration, which does not go beyond gentle contact for a brief moment, is enough to achieve the adhesion effect, while in other cases a longer-term period of exposure to a high pressure may also be necessary.

Pressure-sensitive adhesives have particular, characteristic viscoelastic properties which result in the permanent tack and adhesiveness. A characteristic of these adhesives is that when they are mechanically deformed, there are processes of viscous flow and there is also development of elastic forces of recovery. The two processes have a certain relationship to one another in terms of their respective proportion, in dependence not only on the precise composition, the structure and the degree of crosslinking of the pressure-sensitive adhesive but also on the rate and duration of the deformation, and on the temperature.

The proportional viscous flow is necessary for the achievement of adhesion. Only the viscous components, brought about by macromolecules with relatively high mobility, permit effective wetting and effective flow onto the substrate where bonding is to take place. A high viscous flow component results in high tack (also referred to as surface stickiness) and hence often also to a high peel adhesion. Highly crosslinked systems, crystalline polymers or polymers with glasslike solidification lack flowable components and are therefore in general devoid of tack or possess only little tack at least.

The proportional elastic forces of recovery are necessary for the attainment of cohesion. They are brought about, for example, by very long-chain macromolecules with a high degree of coiling, and also by physically or chemically crosslinked macromolecules, and they permit the transmission of the forces that act on an adhesive bond. As a result of these forces of recovery, an adhesive bond is able to withstand a long-term load acting on it, in the form of a long-term shearing load, for example, sufficiently over a relatively long time period.

For the more precise description and quantification of the extent of elastic and viscous components, and also of the ratio of the components to one another, the variables of storage modulus (G′) and loss modulus (G″) are employed, and can be determined by means of Dynamic Mechanical Analysis (DMA). G′ is a measure of the elastic component, G″ a measure of the viscous component of a substance. Both variables are dependent on the deformation frequency and the temperature.

The variables can be determined with the aid of a rheometer. In that case, for example, the material under investigation is exposed in a plate/plate arrangement to a sinusoidally oscillating shearing stress. In the case of instruments operating with shear stress control, the deformation is measured as a function of time, and the time offset of this deformation relative to the introduction of the shearing stress is measured. This time offset is referred to as phase angle δ.

The storage modulus G′ is defined as follows: G′=(τ/γ)*cos(δ) (τ=shear stress, γ=deformation, δ=phase angle=phase shift between shear stress vector and deformation vector). The definition of the loss modulus G″ is as follows: G″=(τ/γ)*sin(δ) (τ=shear stress, γ=deformation, δ=phase angle=phase shift between shear stress vector and deformation vector).

A composition is considered in general to be pressure-sensitively adhesive, and is defined in the sense of the invention as such, if at room temperature—presently, by definition, 23° C.—in the deformation frequency range from 10⁰ to 10¹ rad/sec, G′ is located at least partly in the range from 10³ to 10⁷ Pa, and G″ likewise lies at least partly in this range. “Partly” means that at least one section of the G′ curve lies within the window described by the deformation frequency range from 10⁰ inclusive up to 10¹ inclusive rad/sec (abscissa) and by the G′ value range from 10³ inclusive up to 10⁷ inclusive Pa (ordinate). For G″ this applies correspondingly.

A “poly(meth)acrylate” is a polymer whose monomer basis consists to an extent of at least 70 wt % of acrylic acid, methacrylic acid, acrylic esters and/or methacrylic esters, with acrylic esters and/or methacrylic esters being present at not less than 50 wt %, based in each case on the overall monomer composition of the polymer in question. Poly(meth)acrylates are obtainable generally by radical polymerization of acrylic and/or methacrylic monomers and also, optionally, other copolymerizable monomers. In accordance with the invention the term “poly(meth)acrylate” encompasses not only polymers based on acrylic acid and/or derivatives thereof but also those based on acrylic acid and methacrylic acid and/or derivatives thereof, and those based on methacrylic acid and/or derivatives thereof.

The term “poly(meth)acrylate” is understood accordingly to encompass both polyacrylates and polymethacrylates and also copolymers composed of acrylate and methacrylate monomers. Similar comments apply in respect of designations such as “(meth)acrylate” and the like.

A “crosslinkable poly(meth)acrylate” is a poly(meth)acrylate which is able to react chemically with component b) of the composition of the invention in such a way that individual polymer strands of the poly(meth)acrylate are joined to one another as a result and optionally as a result of follow-on reactions. This reaction is referred to in accordance with the invention as “crosslinking reaction” of the poly(meth)acrylate. In particular the crosslinkable poly(meth)acrylate contains functionalities which are able to react chemically with the cyclic ether groups of the organosilane conforming to the formula (1).

The crosslinkable poly(meth)acrylates (also below simply “the poly(meth)acrylate” or “the poly(meth)acrylates”) in the composition of the invention preferably comprise plasticizing monomers, monomers having functional groups which are able to react with the cyclic ether functions, and also, optionally, further copolymerizable comonomers, more particularly hardening monomers. In order to ensure the crosslinkability of the poly(meth)acrylate in the composition of the invention, the poly(meth)acrylate preferably contains functions selected from acid groups, selected with particular preference in turn from carboxylic, sulphonic and phosphonic acid groups; hydroxyl groups, acid anhydride groups and amino groups. More preferably the poly(meth)acrylate in the composition of the invention comprises hydroxyl and/or carboxylic acid groups.

The monomer composition of the crosslinkable poly(meth)acrylate preferably further comprises at least one monomer selected from acrylic and/or methacrylic esters having up to 30 C atoms, vinyl esters of carboxylic acids containing up to 20 C atoms, vinyl aromatics having up to 20 C atoms, ethylenically unsaturated nitriles, vinyl halides, vinyl ethers of alcohols containing 1 to 10 C atoms, and aliphatic hydrocarbons having 2 to 8 C atoms and one or two double bonds.

The nature of the poly(meth)acrylate and hence the nature of the PSA to be prepared can be influenced in particular by varying the glass transition temperature of the polymer by means of different weight fractions of the individual monomers. The fractions of the monomers are preferably selected such that the poly(meth)acrylate has a static glass transition temperature of ≦15° C. The figures for the static glass transition temperatures are based on the determination by Differential Scanning Calorimetry (DSC).

For orienting the monomer composition to a desired glass transition temperature, it is advantageous to employ an equation (E1) in analogy to the Fox equation (cf. T. G. Fox, Bull. Am. Phys. Soc. 1 (1956) 123):

$$\frac{1}{{T}_{ℊ}} = {\sum }_{n} \frac{{w}_{n}}{{T}_{ℊ , n}} . \qquad ( E1 )$$

In this equation, n represents the serial number of the monomers used, wₙ the mass fraction of the respective monomer n (wt %) and T_{g,n} the respective glass transition temperature of the homopolymer of the respective monomer n in K.

The crosslinkable poly(meth)acrylate in the composition of the invention can preferably be traced back to the following monomer composition:

d) acrylic esters and/or methacrylic esters of the formula (2)

CH₂═C(R^{I})(COOR^{II}) (2),

in which R^{I} is H or CH₃ and R^{II} is an alkyl radical having 4 to 14 C atoms, more preferably having 4 to 9 C atoms;

e) olefinically unsaturated monomers having functional groups which exhibit reactivity with at least one organosilane conforming to the formula (1);

f) optionally further olefinically unsaturated monomers which are copolymerizable with the monomers (d) and (e).

Preferably the monomers of component (d) are present in a fraction of 45 to 99 wt %, the monomers of component (e) in a fraction of 1 to 15 wt % and the monomers of component (f) in a fraction of 0 to 40 wt %, based in each case on the total weight of the monomer composition.

For application as a pressure sensitive hot melt adhesive, in other words as a material which becomes tacky only on heating, the fractions of components (d), (e) and (f) are preferably selected such that the copolymer has a glass transition temperature (T_{g}) of 15° C. to 100° C., preferably of 30° C. to 80° C., more preferably of 40° C. to 60° C.

A viscoelastic material which can be laminated with pressure-sensitively adhesive layers on both sides preferably has a glass transition temperature (T_{g}) of −70° C. to 100° C., preferably of −50° C. to 60° C., more preferably of −45° C. to 40° C. The fractions of the monomers (d), (e) and (f) may also be selected appropriately for this purpose.

The monomers of component (d) are, in particular, plasticizing and/or apolar monomers. Preference is given to using, as monomers (d), (meth)acrylic monomers selected from acrylic and methacrylic esters having alkyl groups consisting of 4 to 18 C atoms. Examples of such monomers are n-butyl acrylate, n-butyl methacrylate, n-pentyl acrylate, n-pentyl methacrylate, n-amyl acrylate, n-hexyl acrylate, n-hexyl methacrylate, n-heptyl acrylate, n-octyl acrylate, n-octyl methacrylate, n-nonyl acrylate, isobutyl acrylate, isooctyl acrylate, isooctyl methacrylate, dodecyl acrylate, heptadecyl acrylate, octadecyl acrylate and the branched isomers thereof, such as 2-ethylhexyl acrylate and 2-ethylhexyl methacrylate, for example.

The monomers of component (e) are, in particular, olefinically unsaturated monomers having functional groups which are able to enter into reaction with the cyclic ether groups. Preferably the monomers (e) are selected from olefinically unsaturated monomers which contain hydroxy, carboxyl, sulphonic acid, phosphonic acid, acid anhydride and/or amino groups. With particular preference the monomers of component (e) are selected from acrylic acid, methacrylic acid, itaconic acid, maleic acid, fumaric acid, crotonic acid, aconitic acid, dimethylacrylic acid, β-acryloyloxypropionic acid, trichloroacrylic acid, vinylacetic acid, vinylphosphonic acid, maleic anhydride, 2-hydroxyethyl acrylate, 3-hydroxypropyl acrylate, 2-hydroxyethyl methacrylate, 3-hydroxypropyl methacrylate, 6-hydroxyhexyl methacrylate and allyl alcohol.

Employable as monomers (f) in principle are all vinylically functionalized compounds which are copolymerizable with the monomers (d) and/or (e). The monomers (f) are preferably selected from methyl acrylate, ethyl acrylate, propyl acrylate, methyl methacrylate, ethyl methacrylate, benzyl acrylate, benzyl methacrylate, phenyl acrylate, phenyl methacrylate, isobornyl acrylate, isobornyl methacrylate, tert-butylphenyl acrylate, tert-butylphenyl methacrylate, cyclohexyl methacrylate, cyclopentyl methacrylate, phenoxyethyl acrylate, phenoxyethyl methacrylate, 2-butoxyethyl methacrylate, 2-butoxyethyl acrylate, 3,3,5-trimethylcyclohexyl acrylate, 3,5-dimethyladamantyl acrylate, 4-cumylphenyl methacrylate, cyanoethyl acrylate, cyanoethyl methacrylate, 4-biphenylyl acrylate, 4-biphenylyl methacrylate, 2-naphthyl acrylate, 2-naphthyl methacrylate, tetrahydrofurfuryl acrylate, N,N-diethylaminoethyl acrylate, N,N-diethylaminoethyl methacrylate, N,N-dimethylaminoethyl acrylate, N—N-dimethylaminoethyl methacrylate, methyl 3-methoxyacrylate, 3-methoxybutyl acrylate, butyl diglycol methacrylate, ethylene glycol acrylate, ethylene glycol monomethyl acrylate, methoxypolyethylene glycol methacrylate 350, methoxypolyethylene glycol methacrylate 500, propylene glycol monomethacrylate, butoxydiethylene glycol methacrylate, ethoxytriethylene glycol methacrylate, octafluoropentyl acrylate, octafluoropentyl methacrylate, 2,2,2-trifluoroethyl methacrylate, 1,1,1,3,3,3-hexafluoroisopropyl acrylate, 1,1,1,3,3,3-hexafluoroisopropyl methacrylate, 2,2,3,3,3-pentafluoropropyl methacrylate, 2,2,3,3,4,4-hexafluorobutyl methacrylate, 2,2,3,3,4,4,4-heptafluorobutyl acrylate, 2,2,3,3,4,4,4-heptafluorobutyl methacrylate, 2,2,3,3,4,4,5,5,6,6,7,7,8,8,8-pentadeca-fluorooctyl methacrylate, dimethylaminopropylacrylamide, dimethylaminopropyl-methacrylamide, N-(1-methylundecyl)acrylamide, N-(n-butoxymethyl)acrylamide, N-(butoxymethyl)methacrylamide, N-(ethoxymethyl)acrylamide, N-(n-octadecyl)-acrylamide, N,N-dialkyl-substituted amides such as, for example, N,N-dimethylacrylamide, N,N-dimethylmethacrylamide; N-benzylacrylamide, N-isopropylacrylamide, N-tert-butylacrylamide, N-tert-octylacrylamide, N-methylolacrylamide, N-methylolmethacrylamide; acrylonitrile, methacrylonitrile; vinyl ethers such as vinyl methyl ether, ethyl vinyl ether, vinyl isobutyl ether; vinyl esters such as vinyl acetate; vinyl chloride, vinyl halides, vinylidene chloride, vinylidene halides, vinylpyridine, 4-vinylpyridine, N-vinylphthalimide, N-vinyllactam, N-vinylpyrrolidone, styrene, o- and p-methylstyrene, α-butylstyrene, 4-n-butylstyrene, 4-n-decylstyrene, 3,4-dimethoxystyrene, macromonomers such as 2-polystyrene-ethyl methacrylate (molecular weight M_{w} of 4000 to 13 000 g/mol) and poly(methyl methacrylate)-ethyl methacrylate (M_{w} of 2000 to 8000 g/mol).

Monomers of component (f) may advantageously also be selected such that they contain functional groups which support subsequent radiation-chemical crosslinking (by electron beams or UV, for example). Suitable copolymerizable photoinitiators are, for example, benzoin acrylate and acrylate-functionalized benzophenone derivative monomers, tetrahydrofurfuryl acrylate, N-tert-butylacrylamide and allyl acrylate.

With particular preference, if the composition of the invention comprises two or more crosslinkable poly(meth)acrylates, all crosslinkable poly(meth)acrylates in the composition of the invention can be traced back to the monomer composition described above.

The poly(meth)acrylates may be prepared by methods familiar to the skilled person, in particular by conventional radical polymerizations or controlled radical polymerizations. The poly(meth)acrylates may be prepared by copolymerization of the monomeric components, using the customary polymerization initiators and also, where appropriate, chain transfer agents, and conducting polymerization at the customary temperatures in bulk, in emulsion, for example in water, liquid hydrocarbons, or in solution.

The polyacrylates are prepared preferably by polymerizing the monomers in solvents, more particularly in solvents with a boiling range of 50 to 150° C., preferably of 60 to 120° C., using the customary amounts of polymerization initiators, which are in general 0.01 to 5, more particularly 0.1 to 2 wt %, based on the total weight of the monomers.

Initiators suitable in principle are all those familiar to the skilled person for acrylates. Examples of radical sources are peroxides, hydroperoxides and azo compounds, e.g. dibenzoyl peroxide, cumene hydroperoxide, cyclohexanone peroxide, di-tert-butyl peroxide, cyclohexylsulphonyl acetyl peroxide, diisopropyl percarbonate, tert-butyl peroctoate, benzopinacol. Preferred radical initiators used are 2,2′-azobis(2-methylbutyronitrile) (Vazo® 67™ from DUPONT) or 2,2′-azobis(2-methylpropionitrile) (2,2′-azobisisobutyronitrile; AIBN; Vazo® 64™ from DUPONT).

Suitable solvents include alcohols such as methanol, ethanol, n- and isopropanol, n- and isobutanol, preferably isopropanol and/or isobutanol; and also hydrocarbons such as toluene and, in particular, benzines with a boiling range of 60 to 120° C. More particularly it is possible to employ ketones, examples being acetone, methyl ethyl ketone, and methyl isobutyl ketone, and esters, example being ethyl acetate, and also mixtures of the stated solvents, preference being given to mixtures which contain isopropanol, in particular in amounts of 2 to 15 wt %, in particular 3 to 10 wt %, based on the solvent mixture employed.

The weight-average molecular weights M_{w} of the poly(meth)acrylates are preferably from 20 000 to 2 000 000 g/mol, more preferably from 100 000 to 1 500 000 g/mol and very preferably from 400 000 to 1 200 000 g/mol (gel permeation chromatography; see experimental section). To bring about these values it may be advantageous to conduct the polymerization in the presence of suitable chain transfer agents such as thiols, halogen compounds and/or alcohols.

The poly(meth)acrylate in the composition of the invention preferably has a K value of 30 to 90, more preferably of 40 to 70, as measured in toluene (1% strength solution, 21° C.). The K value of Fikentscher is a measure of the molecular weight and the viscosity of the polymer.

The composition of the invention comprises at least one organosilane conforming to the formula (1)

R¹—Si(OR²)ₙR³ₘ (1),

in which R¹ is a radical containing a cyclic ether function,

the radicals R² independently of one another are each an alkyl or acyl radical,

R³ is a hydroxyl group or an alkyl radical, and

n is 2 or 3 and m is the number resulting from 3-n.

Organosilanes of this kind are able to react with reactive groups in the crosslinkable poly(meth)acrylate. The invention provides both for linking of reactive groups in the crosslinkable poly(meth)acrylates with the cyclic ether functions, and for condensation reactions of the hydrolysable silyl groups of the organosilanes conforming to the formula (1). The organosilanes conforming to the formula (1) in this way permit linking of the poly(meth)acrylates with one another, and are incorporated into the network which forms.

The radical R¹ in the formula (1) contains preferably an epoxide group or oxetane group as cyclic ether function. More preferably R¹ contains a glycidyloxy, 3-oxetanylmethoxy or epoxycyclohexyl group. Likewise preferably R¹ is an alkyl or alkoxy radical which contains an epoxide group or oxetane group and has 2 to 12 carbon atoms. R¹ is selected more particularly from the group consisting of a 3-glycidyloxypropyl radical, a 3,4-epoxycyclohexyl radical, a 2-(3,4-epoxycyclohexyl)ethyl radical and a 3-[(3-ethyl-3-oxetanyl)methoxy]propyl radical.

The radicals R² in the formula (1) are preferably, independently of one another, each an alkyl group, more preferably independently of one another each a methyl, ethyl, propyl or isopropyl group, and very preferably independently of one another each a methyl or ethyl group. This is advantageous because alkoxy groups, and especially methoxy and ethoxy groups, can be hydrolysed easily and quickly, and the alcohols formed as elimination products can be removed comparatively easily from the composition and have no critical toxicity.

R³ in the formula (1) is preferably a methyl group.

The at least one organosilane conforming to the formula (1) is more preferably selected from the group consisting of (3-glycidyloxypropyl)trimethoxysilane (CAS No. 2530-83-8, e.g. Dynasylan® GLYMO, Evonik), (3-glycidyloxypropyl)triethoxysilane (CAS No. 2602-34-8, e.g. Dynasylan® GLYEO, Evonik), (3-glycidyloxypropyl)methyldimethoxysilane (CAS No. 65799-47-5, e.g. Gelest Inc.), (3-glycidyloxypropyl)methyldiethoxysilane (CAS No. 2897-60-1, e.g. Gelest Inc.), 5,6-epoxyhexyltriethoxysilane (CAS No. 86138-01-4, e.g. Gelest Inc.), [2-(3,4-epoxycyclohexyl)ethyl]trimethoxysilane (CAS No. 3388-04-3, e.g. Sigma-Aldrich), [2-(3,4-epoxycyclohexyl)ethyl]triethoxysilane (CAS No. 10217-34-2, e.g. ABCR GmbH), triethoxy[3-[(3-ethyl-3-oxetanyl)methoxy]propyl]silane (CAS No. 220520-33-2, e.g. Aron Oxetane OXT-610, Toagosei Co., Ltd.).

In the composition of the invention, organosilanes conforming to the formula (1) are present preferably in total at 0.05 to 3 wt %, more preferably at 0.05 to 1 wt %, more particularly at 0.05 to 0.5 wt %, as for example at 0.05 to 0.3 wt %, based in each case on the total weight of the composition.

In accordance with the invention it is possible, in addition to the organosilane or organosilanes conforming to the formula (1), for multifunctional epoxides or oxetanes additionally to be present as crosslinkers in the composition of the invention. They are preferably selected from 1,4-butanediol diglycidyl ether, polyglycerol-3 glycidyl ether, cyclohexanedimethanol diglycidyl ether, glycerol triglycidyl ether, neopentyl glycol diglycidyl ether, pentaerythritol tetraglycidyl ether, 1,6-hexanediol diglycidyl ether, polypropylene glycol diglycidyl ether, trimethylolpropane triglycidyl ether, bisphenol A diglycidyl ether, bisphenol F diglycidyl ether, bis[1-ethyl(3-oxetanyl)]methyl ether, 2,4:3,5-dianhydrido-1,6-di-O-benzoylmannitol and 1,4-bis[2,2-dimethyl-1,3-dioxolan-4-yl]-3,3-dimethyl-2,5-dioxabicyclo[2.1.0]pentane.

The composition of the invention further comprises at least one substance (accelerator) which accelerates the reaction of the crosslinkable poly(meth)acrylate with the cyclic ether functions. Substance with accelerating effect means in particular that the substance supports the first crosslinking reaction—the attachment of the cyclic ether functions to the poly(meth)acrylate—to an extent such as to provide for sufficient reaction rate, whereas the reaction would run not at all or only with insufficient slowness in the absence of the accelerator, especially below the melting temperature of the poly(meth)acrylates. An accelerator of this kind is also per se capable of accelerating the hydrolysis of the organic silane in the presence of moisture, and the subsequent condensation reaction of the resultant silanols. The accelerator therefore ensures a substantial improvement in the kinetics of the crosslinking reaction. This may take place, in accordance with the invention, catalytically, but also by integration into the reaction events.

For a definition of a melt of an amorphous polymer such as of a poly(meth)acrylate, for example, reference is made in accordance with the invention to the criteria used in F. R. Schwarzl, Polymermechanik: Struktur und mechanisches Verhalten von Polymeren, Springer Verlag, Berlin, 1990 on pages 89 ff., whereby the viscosity has an order of magnitude of about η≈10⁴ Pa·s and the internal damping attains tan δ values of ≧1.

The substance accelerating the reaction of the crosslinkable poly(meth)acrylate with the cyclic ether functions preferably contains at least one basic function, more preferably at least one amino group, or is an organic amine. In the case of an organic amine, starting from ammonia, at least one hydrogen atom is replaced by an organic group, more particularly by an alkyl group. Among the amino groups and amines, preference is given to those which enter into no reactions or only very slow reactions with the building blocks of the poly(meth)acrylates. “Slow reactions” in this context means “reactions which proceed substantially slower than the activation of the cyclic ether functions”. Suitable in principle are primary (NRH₂), secondary (NR₂H) and tertiary (NR₃) amines, and also, of course, those which have two or more primary and/or secondary and/or tertiary amino groups, such as diamines, triamines and/or tetramines. Examples of suitable accelerators are pyridine, imidazoles (such as, for example, 2-methylimidazole), 1,8-diazabicyclo[5.4.0]undec-7-ene, cycloaliphatic polyamines, isophoronediamine; phosphate-based accelerators such as phosphines and/or phosphonium compounds, as for example triphenylphosphine or tetraphenylphosphonium tetraphenylborate. With particular preference the substance accelerating the reaction of the poly(meth)acrylate with the cyclic ether functions contains at least one amino group.

As a result of the basic functionality present preferably in the accelerator, an accelerating effect is exerted not only on the reaction of the reactive groups of the poly(meth)acrylate with the cyclic ether groups of the crosslinker conforming to the formula (1), but also on the hydrolysis of the organic silanes conforming to the formula (1) and also the subsequent condensation reaction of the resultant silanols. The accelerator substance therefore has an accelerating effect for the entire crosslinking mechanism.

The substance accelerating the reaction of the crosslinkable poly(meth)acrylate with the cyclic ether functions is very preferably an organosilane containing at least one amino group and at least one alkoxy group or acyloxy group. Accordingly, the substance with accelerating effect can be incorporated by the silane functionality into the resultant network, and the product properties can be adjusted with even greater precision. In particular, the substance accelerating the reaction of the poly(meth)acrylate with the cyclic ether functions is selected from the group consisting of N-cyclohexyl-3-aminopropyltrimethoxysilane (CAS No. 3068-78-8, e.g. Wacker), N-cyclohexylaminomethyltriethoxysilane (CAS No. 26495-91-0, e.g. Wacker), 3-aminopropyltrimethoxysilane (CAS No. 13822-56-5, e.g. Gelest Inc.), 3-aminopropyltriethoxysilane (CAS No. 919-30-2, e.g. Gelest Inc.), 3-aminopropylmethyldiethoxysilane (CAS No. 3179-76-8, e.g. Gelest Inc.), 3-(2-aminomethylamino)propyltriethoxysilane (CAS No. 5089-72-5, e.g. Wacker), 3-(N,N-dimethylaminopropyl)trimethoxysilane (CAS No. 2530-86-1, e.g. Gelest Inc.), bis(2-hydroxyethyl)-3-aminopropyltriethoxysilane (CAS No. 7538-44-5, e.g. Gelest Inc.).

The use of an accelerator is an advantage fundamentally because epoxides, for example, without such accelerators react only under the influence of heat, and more particularly do so only after prolonged supply of thermal energy. Oxetanes, for their part, would react even more poorly without catalysts or accelerators. Certain accelerator substances, such as ZnCl₂, for example, do improve the reactivity in the temperature range of the melt, yet in the absence of a supply of thermal energy from outside (at room temperature, therefore, for example) the reactivity of many epoxides or oxetanes subsides even in the presence of the accelerators, and so the crosslinking reaction proceeds more slowly. This is a drawback especially when poly(meth)acrylates processed as hot melts are applied within relatively short time periods (several minutes, for example) and then cool rapidly to room temperature or storage temperature, in the absence of further supply of heat. In these cases, without the initiation of a further crosslinking reaction, it is not possible to achieve very high degrees of crosslinking, resulting in inadequate cohesion for certain areas of application of polyacrylates.

If the crosslinker system were to be put into the polyacrylate system with accelerators functioning more under hot conditions, as for example epoxide or oxetane crosslinkers with ZnCl₂, or alternatively were to be put too early into said system (in order to achieve a high degree of crosslinking), it would no longer be possible for the compositions to be processed homogeneously, and especially to be compounded and applied, since they would crosslink too greatly too quickly.

Basic accelerators, in contrast, ensure relatively long pot lives and also improved adjustability of the desired cohesion of the polymer.

Through the combination of the silane crosslinkers of the invention, conforming to the formula (1), with the accelerators comprising an amino group and a hydrolysable silyl group, a thermal crosslinking process is made possible that, in the context of the processing of polyacrylate compositions in the melt, is less susceptible to uncontrolled reactions (gelling of the composition) and, advantageously, allows long pot lives. Particularly during coating out or application to a carrier, therefore, a uniform, bubble-free coating can be created. The preferred crosslinker-accelerator system also permits optimum further crosslinking of the polyacrylate after processing, more particularly after coating out or application to a carrier, and after the associated cooling. This occurs without the need for actinic irradiation, takes place with a high crosslinking rate, and, moreover, produces improved product properties.

In particular, therefore, the poly(meth)acrylates, as a result of the preferred crosslinker-accelerator system, are capable of further crosslinking without further actively—that is, process-engineeringly—supplied thermal energy (heating). This is the case in particular also for cooling of the poly(meth)acrylates down to room temperature. It is therefore possible, advantageously, to do without heating, without a consequent substantial deceleration of the crosslinking reaction. In a hot melt operation, therefore, after the thermal activation, the system is able to continue crosslinking even at room temperature and, after a certain time, to attain a stable degree of crosslinking.

Another advantage of the accelerators comprising an amino group and a hydrolysable silyl group is that they remain as a non-volatile component in the adhesive, being incorporated into the polymer covalently by condensation reaction of the silyl groups and therefore no longer being able to migrate to the interface with the substrate.

Accelerators are present advantageously at in total 0.07-2 wt %, based on the total weight of the composition, in the composition of the invention.

It is particularly advantageous if the crosslinker fraction is selected such as to result in an elastic component of at least 20% of the crosslinked polyacrylates. The elastic component is preferably at least 40%, more preferably at least 60% (measured in each case according to measurement method H3; cf. experimental section).

For stating the crosslinking ratios it is possible in particular to employ the ratio of the number of cyclic ether functions in the organosilanes conforming to the formula (1) to the number of reactive functional groups in the poly(meth)acrylates. In principle this ratio is freely selectable, giving either an excess of functional groups on the part of the poly(meth)acrylates, numerical equality of the groups, or an excess of cyclic ether groups in the crosslinker. This ratio is preferably selected such that the cyclic ether groups of the organosilanes conforming to the formula (1) are present in a deficit up to at most numerical equality. With particular preference the ratio of the total number of cyclic ether groups in the organosilanes conforming to the formula (1) to the number of groups reactive therewith in the poly(meth)acrylates is from 0.05:1 to 1:1. Besides this, the properties of the PSA obtained after crosslinking has taken place—especially the elasticity of this PSA—can also be adjusted via the number of water-eliminable groups in the organosilanes conforming to the formula (1), and also via the amount of accelerator substances.

Another characteristic number is the ratio of the number of acceleration-active groups in the accelerator to the number of cyclic ether groups in the crosslinker. This ratio as well can in principle be selected freely, giving either an excess of acceleration-active groups, numerical equality of the groups, or an excess of the cyclic ether groups. The ratio of the number of acceleration-active groups in the accelerators to the number of cyclic ether groups in the crosslinker is preferably from 0.2:1 to 4:1.

As regards the hydrolysable silyl groups of the crosslinkers, it is preferred if the ratio of the number of —OR² groups as per formula (1) to the total number of cyclic ether groups and of basic groups with accelerating effect is at least 1.5:1, more preferably at least 2:1.

In one specific embodiment, the composition of the invention comprises at least one tackifying resin. The tackifying resin is preferably selected from aliphatic, aromatic and alkylaromatic hydrocarbon resins, hydrogenated hydrocarbon resins, functional hydrocarbon resins and natural resins. More preferably the tackifying resin is selected from pinene resins, indene resins and rosins, their disproportionated, hydrogenated, polymerized and/or esterified derivatives and salts, terpene resins and terpene-phenolic resins, and also C5, C9 and other hydrocarbon resins. Combinations of these and further resins may also be used advantageously in order to adjust the properties of the resultant adhesive in line with requirements. More particularly, the tackifying resin is compatible with the poly(meth)acrylates in the composition of the invention, compatibility being understood essentially to mean “soluble therein”. Very preferably the tackifying resin is selected from terpene-phenolic resins and rosin esters.

The composition of the invention may further comprise pulverulent and granular fillers, dyes and pigments such as, for example chalks (CaCO₃), titanium dioxides, zinc oxides and carbon blacks, even in high proportions, in other words from 1 to 50 wt %, based on the total weight of the composition. These substances are notable in particular for their reinforcing and/or abrasive effect.

The composition of the invention preferably comprises at least one chalk, more preferably Mikrosöhl chalk. Chalk is present preferably at not more than 30 wt %, based on the total weight of the composition. This has the advantage that there is virtually no change in the technical adhesive properties such as shear strength at room temperature and instantaneous peel adhesion on steel and PE, while on the other hand the chalk acts as an advantageously reinforcing filler.

Furthermore, the composition of the invention may comprise low-flammability fillers such as, for example, ammonium polyphosphate and aluminium diethylphosphinate; electrically conductive fillers such as, for example, conductive carbon black, carbon fibres and/or silver-coated beads; thermally conductive materials such as, for example, boron nitride, aluminium oxide, silicon carbide; ferromagnetic additives such as, for example, iron(III) oxides; additives for increasing volume, especially for producing foamed layers, such as, for example, expandants, solid glass beads, hollow glass beads, microbeads made of other materials, expandable microballoons; silica, silicates; organically renewing raw materials, an example being wood flour; organic and/or inorganic nanoparticles; fibres; inorganic and/or organic colorants in the form of pastes, compounds or pigments; ageing inhibitors, light stabilizers, ozone protectants and/or compounding agents. These constituents may be added or incorporated by compounding before or after the concentration of the polyacrylate Ageing inhibitors which can be added include both primary ageing inhibitors, such as 4-methoxyphenol, and secondary ageing inhibitors, an example being Irgafos® TNPP from BASF, in combination with one another as well; additionally, phenothiazine (C radical scavenger) or hydroquinone methyl ether in the presence of oxygen, and also oxygen itself, can be used.

The composition of the invention may further comprise one or more plasticizers (plasticizing agents), more particularly at concentrations of up to 5 wt %. Examples of plasticizers that may be present include low molecular mass polyacrylates, phthalates, water-soluble plasticizers, plasticizing resins, phosphates, polyphosphates and/or citrates.

Besides the crosslinkable poly(meth)acrylate, furthermore, the composition of the invention may comprise other polymers, blended or mixed with the poly(meth)acrylates. For example, the composition may comprise at least one polymer selected from natural rubber, synthetic rubbers, EVA, silicone rubbers, acrylic rubbers and polyvinyl ethers. These polymers are preferably present in granulated or otherwise-comminuted form. They are preferably added before the thermal crosslinker is added. The polymer blends are produced preferably in an extruder, more preferably in a multiple-screw extruder or in a planetary roller mixer.

In order to stabilize the thermally crosslinked acrylate hot melts, including, in particular, polymer blends of thermally crosslinked acrylate hot melts and other polymers, it may be sensible to subject the shaped material to low doses of electronic irradiation. For this purpose, the composition of the invention may comprise appropriate crosslinking promoters such as di-, tri- or polyfunctional acrylate, polyester and/or urethane acrylate.

A further aspect of the invention relates to a method for crosslinking a composition which comprises at least one crosslinkable poly(meth)acrylate, at least one organosilane conforming to the formula (1) and at least one substance which accelerates the reaction of the crosslinkable poly(meth)acrylate with the cyclic ether functions, the method comprising the heating of the composition to a temperature which is sufficient for initiating the crosslinking reaction.

In the context of the method of the invention, the crosslinking is initiated preferably in the melt of the poly(meth)acrylate and the poly(meth)acrylate is thereafter cooled at a point in time at which it is still outstandingly amenable to processing—thus being, for example, capable of homogeneous application and/or shaping. For adhesive tapes in particular, a homogeneous, uniform coat is needed, where there ought to be no lumps, gel specks or the like within the layer of adhesive. Polyacrylates of corresponding homogeneity are also demanded for the other forms of application.

A poly(meth)acrylate can be shaped if it has not yet crosslinked or has crosslinked only to a low degree; advantageously, the degree of crosslinking of the poly(meth)acrylate at the start of cooling is not more than 10%, preferably not more than 3%, even better not more than 1% of the desired final degree of crosslinking. The crosslinking reaction preferably progresses after cooling as well, until the final degree of crosslinking has been attained. The term “cooling”, here and below, also includes the passive step of allowing the system to cool by removal of the heating.

In the context of the method of the invention, crosslinking is preferably initiated at a point in time shortly before further processing, particularly before shaping or coating. It takes place commonly in a processing reactor (compounder, such as an extruder, for example). The composition is then taken from the compounder and subjected as desired to further processing and/or shaping. During processing and/or shaping or thereafter, the polyacrylate is cooled, either by active cooling and/or adjustment of the heating, or by heating of the polyacrylate to a temperature below the processing temperature (possibly here again after active cooling beforehand), if the temperature is not to drop to room temperature.

The further processing and/or shaping may in particular comprise coating application to a permanent or temporary carrier.

In one advantageous variant of the method of the invention, the polyacrylate, during or after removal from the processing reactor, is coated onto a permanent or temporary carrier and is cooled during or after application to room temperature (or to a temperature in the vicinity of room temperature), in particular immediately after application.

Initiation “shortly before” further processing means in particular that at least one of the components needed for the crosslinking (preferably an organosilane of the formula (1)) is added to the hot melt (i.e. to the melt) as late as possible, but as early as needed, in order to achieve effective homogenization with the polymer composition.

The crosslinker-accelerator system is selected preferably such that the crosslinking reaction advances at a temperature below the melting temperature of the polyacrylate composition, in particular at room temperature. The possibility of crosslinking at room temperature offers the advantage that no additional energy need be supplied.

The term “crosslinking at room temperature” refers in this context in particular to the crosslinking at customary storage temperatures of adhesive tapes, non-tacky viscoelastic materials or the like, and accordingly is not intended to be confined to 20° C. In accordance with the invention, of course, it is also advantageous if the storage temperature deviates from 20° C., owing to weather-related or other temperature fluctuations, or if local circumstances cause the room temperature to differ from 20° C., and if the crosslinking proceeds without further supply of energy.

The production of the composition of the invention and hence also the method for crosslinking the composition of the invention preferably each comprise concentration of the crosslinkable poly(meth)acrylate. The polymer can be concentrated in the absence of the crosslinker substances and, optionally, of the accelerator substances. It is, however, also possible for one of these classes of compound to be added to the polymer even prior to the concentration, in which case concentration takes place in the presence of this or these substance(s).

The polymers are then transferred into a compounder. In particular embodiments of the method of the invention, concentration and compounding may take place in the same reactor.

The compounder used may more particularly be an extruder. In the compounder, the poly(meth)acrylates are present in the melt, either having been introduced already in the melt state or having been heated in the compounder until a melt is formed. The polymers are maintained in the melt in the compounder by heating.

As long as there is neither crosslinker (organosilane(s) conforming to the formula (1)) nor accelerator present in the polymer, the possible temperature in the melt is limited by the decomposition temperature of the polymer. The processing temperature in the compounder is customarily between 80 and 150° C., more particularly between 100 and 120° C.

The crosslinking substances are added to the polymer preferably before or with the addition of accelerator.

The organosilanes conforming to the formula (1) may be added to the monomers even before or during the polymerization phase, provided that they are sufficiently stable for this to occur. However, preferably, they are added to the polymer before or during their feed to the compounder, and are therefore introduced together with the polymers into the compounder.

The accelerator substances are added to the polymers preferably shortly before further processing, in particular shortly before coating application or other shaping. The time window of the addition prior to coating is guided in particular by the pot life available, in other words by the working time in the melt without deleterious alteration of the properties in the resulting product. With the method of the invention it has been possible to achieve pot lives of a few minutes up to several tens of minutes (according to the choice of experimental parameters), and so the accelerator ought to be added within this time span prior to coating. Ideally the accelerator is added to the hot melt as late as possible but as early as necessary, in order to ensure effective homogenization with the polymer composition.

Time spans which have emerged as being very advantageous for this are from 2 to 10 minutes, more particularly time spans of more than 5 minutes, at a processing temperature of 110 to 120° C.

The crosslinkers and the accelerators may also both be added shortly before the further processing of the polymer. For this purpose it is advantageous to introduce the crosslinker-accelerator system into the operation simultaneously at a single location.

In principle it is also possible to switch the times of addition and/or locations of addition for crosslinker and accelerator in accordance with the remarks above, so that the accelerator is added ahead of the crosslinker substances.

In the compounding operation, the temperature of the polymer on addition of the crosslinkers and/or of the accelerators is between 50 and 150° C., preferably between 70 and 130° C., more preferably between 80 and 120° C.

After the composition has been compounded, it is subjected to further processing, more particularly to coating onto a permanent or temporary carrier. A permanent carrier remains joined to the layer of adhesive during use, whereas a temporary carrier is removed again in the further processing operation, for example in the converting of the adhesive tape, or is removed again from the layer of adhesive during use.

The self-adhesive compositions can be coated using hotmelt coating nozzles that are known to the person skilled in the art, or, preferably, using roll applicators, also called coating calenders. The coating calenders may be composed advantageously of two, three, four or more rolls.

Preferably at least one and more preferably all of the rolls that come into contact with the composition are provided with an anti-adhesive roll surface. Accordingly, it is possible for all of the rolls of the calender to have an anti-adhesive finish. An anti-adhesive roll surface used is with preference a steel-ceramic-silicone composite. Roll surfaces of this kind are resistant to thermal and mechanical loads. It is particularly advantageous to use roll surfaces which have a surface structure, more particularly of a kind such that the roll surface does not produce full contact with the polymer layer to be processed. This means that the area of contact is lower as compared with a smooth roll. Particularly advantageous are structured rolls such as engraved metal rolls—engraved steel rolls, for example.

Coating may take place in particular in accordance with the coating techniques as set out in WO 2006/027387 A1 at page 12 line 5 to page 20 line 13. The relevant disclosure content of WO 2006/027387 A1 is therefore explicitly included in the disclosure content of the present specification.

Particularly good results are achieved with the two- and three-roll calender stacks through the use of calender rolls which are equipped with anti-adhesive or modified surfaces—particularly preferred are engraved metal rolls. These engraved metal rolls have a regularly geometrically interrupted surface structure. This applies with particular advantage to the transfer roll ÜW. The specific surfaces contribute in a particularly advantageous way to the success of the coating process, since anti-adhesive and structured surfaces allow the polyacrylate composition to be transferred even to anti-adhesively treated backing surfaces. Various kinds of anti-adhesive surface coatings can be used for the calender rolls. Those that have proved to be particularly suitable are, for example, the metal-ceramic-silicone composites Pallas SK-B-012/5 from Pallas Oberflächentechnik GmbH, Germany, and also AST 9984-B from Advanced Surface Technologies, Germany.

In the course of coating, particularly when using the multi-roll calenders, it is possible to realize coating speeds of up to 300 m/min.

Shown by way of example in FIG. 1 of the present specification is the compounding and coating operation, on the basis of a continuous process. The polymers are introduced at the first feed point 1.1 into the compounder 1.3, here for example an extruder. Either the introduction takes place already in the melt, or the polymers are heated in the compounder until the melt state is reached. At the first feed point, together with the polymer, organosilanes conforming to the formula (1) are advantageously introduced into the compounder.

Shortly before coating takes place, the accelerators are added at a second feed point 1.2. The success of this is that the accelerators are added to the polymers not until shortly before coating, and the reaction time in the melt is low.

The reaction regime may also be discontinuous. In corresponding compounders such as reactor tanks, for example, the addition of the polymers, the crosslinkers and the accelerators may take place at different times and not, as shown in FIG. 1, at different locations.

The composition can then be coated using a roll applicator—represented in FIG. 1 by the doctor roll 2 and the coating roll 3—onto a liner or other suitable carrier. Directly after coating application the polymer is only slightly crosslinked, but not yet sufficiently crosslinked. The crosslinking reaction proceeds advantageously on the carrier.

After the coating operation, the polymer composition cools down relatively rapidly, in fact to the storage temperature, in general to room temperature. The crosslinker-accelerator system of the invention is preferably suitable for allowing the crosslinking reaction to continue without the supply of further thermal energy (without heat supply).

The crosslinking reaction between the functional groups of the polyacrylate and the cyclic ether groups of the crosslinker and also between the hydrolysable silyl groups of the crosslinker and preferably also of the accelerator preferably proceeds completely even without heat supply under standard conditions (room temperature). Since crosslinking occurs only when both of the above-described reactions take place, it may be of advantage for one of the two reactions to proceed at a rate such that it takes place partially or completely in the compounder itself. Generally speaking, after a storage time of 5 to 14 days, crosslinking is concluded to a sufficient extent for there to be a functional product present, more particularly an adhesive tape or a functional carrier layer on the basis of the poly(meth)acrylate. The ultimate state and thus the final cohesion of the polymer are attained, depending on the choice of polymer and of crosslinker-accelerator system, after a storage time of in particular 5 to 14 days, advantageously after 5 to 10 days' storage time at room temperature, and—as expected—earlier at a higher storage temperature.

Crosslinking raises the cohesion of the polymer and hence also the shear strength. The links are very stable. This allows very ageing-stable and heat-resistant products such as adhesive tapes, viscoelastic carrier materials or shaped articles. Through the incorporation of the accelerator into the network it is also possible, additionally, to improve the properties under hot and humid conditions.

The physical properties of the end product, especially its viscosity, peel adhesion and tack, can be influenced through the degree of crosslinking, and so the end product can be optimized through an appropriate choice of the reaction conditions. A variety of factors determine the operational window of the process. The most important influencing variables are the amounts (concentrations and proportions relative to one another) and the chemical natures of the crosslinkers and of the accelerators, the operating temperature and coating temperature, the residence time in the compounder (especially extruder) and in the coating assembly, the fraction of functional groups in the poly(meth)acrylate, and the average molecular weight of the poly(meth)acrylate.

Described below are a number of associations related to the preparation of the inventively crosslinked self-adhesive composition, which more closely characterize the production process.

Through the invention it is possible for stably crosslinked poly(meth)acrylates to be offered, and with outstanding control facility in relation to the crosslinking pattern, by virtue of substantial decoupling of degree of crosslinking and reactivity (reaction kinetics). The amount of crosslinker added (the total amount of crosslinkers functionalized with a cyclic ether group, and the total amount of hydrolysable silyl groups in the crosslinker-accelerator system) largely influences the degree of crosslinking of the product; the accelerator largely controls the reactivity.

It has been observed that, through the amount of cyclic ether groups introduced with the crosslinker, in addition to the total amount of hydrolysable silyl groups in the crosslinker-accelerator system it is possible to control the degree of crosslinking, and to do so largely independently of the otherwise selected process parameters of temperature and, optionally, amount of added accelerator.

As is evident for the cyclic ether groups, the degree of crosslinking attained goes up with their concentration, while the reaction kinetics remain virtually unaffected.

It was also determined that, even if the accelerator is incorporated into the network, the amount of accelerator added still has a direct influence over the crosslinking rate, and that the overall reaction rate of the crosslinker-accelerator system of the invention is significantly higher than that of the thermal crosslinker systems known in the prior art. Here it is unnecessary, preferably, to supply any further thermal energy (actively) or to subject the product to further treatment.

For the dependency of the crosslinking time at constant temperature on the accelerator concentration it is found that the ultimate value of the degree of crosslinking remains virtually constant; at high accelerator concentrations, however, this value is achieved more quickly than at low accelerator concentrations.

In addition, the reactivity of the crosslinking reaction can also be influenced by varying the temperature, if desired, especially if the advantage of “inherent crosslinking” in the course of storage under standard conditions has no part to play. At constant crosslinker and accelerator concentration, an increase in the operating temperature leads to a reduced viscosity, which enhances the coatability of the composition but reduces the working time.

An increase in the working time is acquired by a reduction in the accelerator concentration, reduction in polymer molecular weight, reduction in the concentration of functional groups in the polymer, use of less-reactive crosslinkers or of less-reactive crosslinker-accelerator systems, and/or reduction in operating temperature.

An improvement in the cohesion of the composition can be obtained by a variety of pathways. In one, the accelerator concentration is increased, which reduces the working time. At constant accelerator concentration, it is also possible to raise the molecular weight of the polyacrylate. In the sense of the invention it is advantageous in any case to raise the concentration of crosslinker.

Depending on the desired requirements profile of the composition or of the product it is necessary to adapt the abovementioned parameters in a suitable way.

The composition of the invention can be used for a broad range of applications. Below, a number of particularly advantageous fields of use are set out by way of example.

The composition of the invention is used preferably for preparing a pressure-sensitive adhesive (PSA), especially as a PSA for an adhesive tape, where the acrylate PSA is in the form of a single-sided or double-sided film on a carrier sheet. The composition of the invention is especially suitable when a high adhesive coat weight is required in one coat, since with the presented coating technique it is possible to achieve an almost arbitrarily high coat weight, preferably more than 100 g/m², more preferably more than 200 g/m², and to do so in particular in tandem with particularly homogeneous crosslinking through the coat. Examples of specific applications are technical adhesive tapes, more especially for use in construction, examples being insulating tapes, corrosion control tapes, adhesive aluminium tapes, fabric-reinforced film-backed adhesive tapes (duct tapes), special-purpose adhesive construction tapes, such as vapour barriers, adhesive assembly tapes, cable wrapping tapes; self-adhesive sheets and/or paper labels.

The composition of the invention can also be used for preparing a PSA for a carrierless adhesive tape, called an adhesive transfer tape. Here as well, the possibility of setting the coat weight almost arbitrarily high in conjunction with particularly homogeneous crosslinking through the coat is a particular advantage. Preferred weights per unit area are more than 10 g/m² to 5000 g/m², more preferably 100 g/m² to 3000 g/m².

The composition of the invention may also be used for producing a heat-sealing adhesive in adhesive transfer tapes or in single-sided or double-sided adhesive tapes. Here as well, for carrier-containing pressure-sensitive adhesive tapes, the carrier may be a viscoelastic polyacrylate system obtained from the composition of the invention.

The adhesive tapes set out above may be designed advantageously as strippable adhesive tapes, more particularly such that they can be detached again without residue by pulling substantially in the plane of the bond.

The composition of the invention is also particularly suitable for producing three-dimensional shaped articles with or without pressure-sensitive tack. A particular advantage here is that there is no restriction on the layer thickness of the polyacrylate to be crosslinked and shaped, in contrast to UV- and EBC-curing compositions. According to the choice of coating or shaping assemblies, therefore, it is possible to produce structures of any desired shape, which are then able to continue crosslinking to desired strength under mild conditions.

Poly(meth)acrylate-based composition layers with a thickness of more than 80 μm are difficult to produce with the solvent technology, since problems such as bubble formation, very low coating speed, laborious lamination of thin layers one over another, and weak points in the layered assembly occur.

Thick pressure-sensitive adhesive layers based on the composition of the invention may be present, for example, in unfilled form, as straight acrylate, or in resin-blended form and/or in a form filled with organic or inorganic fillers. Also possible are layers foamed to a closed-cell or open-cell form in accordance with known techniques. One possible method of foaming is that of foaming via compressed gases such as nitrogen or CO₂, or foaming via expandants such as hydrazines or expandable microballoons. Where expanding microballoons are used, the composition or the shaped layer is advantageously activated suitably by means of heat introduction. Foaming may take place in the extruder or after coating. It may be judicious to smooth the foamed layer by means of suitable rollers or release films. To produce foam-analogous layers it is also possible to add hollow glass beads or pre-expanded polymeric microballoons to the crosslinked or non-crosslinked composition of the invention.

In particular it is also possible, from the composition of the invention, to produce thick layers which can be used as a carrier layer for double-sidedly PSA-coated adhesive tapes. Preferably these are filled and foamed layers which can be utilized as carrier layers for foam-like adhesive tapes. With these layers as well it is sensible to add solid glass beads, hollow glass beads or expanding microballoons to the polyacrylate prior to the addition of the crosslinker-accelerator system, the crosslinker or the accelerator. Where expanding microballoons are used, the composition on the shaped layer is suitably activated by means of heat introduction. Foaming may take place in the extruder or after coating. It may be judicious to smoothe the foamed layer by means of suitable rollers or release films, or by the lamination of a PSA coated onto a release material. A pressure-sensitive adhesive layer may therefore be laminated onto at least one side of a foamed, viscoelastic layer of this kind. Preference is given to lamination of a corona-pretreated or plasma-pretreated poly(meth)acrylate layer on both sides. Alternatively it is possible to laminate differently pretreated adhesive layers, i.e. pressure-sensitive adhesive layers and/or heat-activatable layers based on polymers other than poly(meth)acrylates, onto the viscoelastic layer. Suitable base polymers for such layers are natural rubber, synthetic rubbers, acrylate block copolymers, styrene block copolymers, EVA, certain polyolefins, polyurethanes, polyvinyl ethers and silicones. Preferred compositions, however, are those which have no significant fractions of migratable constituents whose compatibility with the polyacrylate is sufficient that they diffuse in significant quantities into the acrylate layer and alter the properties therein.

Instead of laminating a pressure-sensitive adhesive layer onto both sides, it is also possible on at least one side to use a melt-adhesive layer or thermally activatable adhesive layer. The asymmetric adhesive tapes obtained in this way permit the bonding of critical substrates with high bonding strength. An adhesive tape of this kind can be used, for example, to affix EPDM rubber profiles to vehicles.

### EXAMPLES

Measurement Methods (General):

Solids Content (Measurement Method A1):

The solids content is a measure of the fraction of non-evaporable constituents in a polymer solution. It is determined gravimetrically, by weighing the solution, then evaporating the evaporable fractions in a drying oven at 120° C. for 2 hours and reweighing the residue.

K Value (According to Fikentscher) (Measurement Method A2):

The K value is a measure of the average molecular size of high-polymer materials. It is measured by preparing one percent strength (1 g/100 ml) toluenic polymer solutions and determining their kinematic viscosities using a Vogel-Ossag viscometer. Standardization to the viscosity of the toluene gives the relative viscosity, from which the K value can be calculated by the method of Fikentscher (Polymer August 1967, 381 ff.)

Gel Permeation Chromatography GPC (Measurement Method A3).

The figures for the weight-average molecular weight M_{w} and the polydispersity PD in this specification relate to the determination by gel permeation chromatography. Determination is made on a 100 μl sample subjected to clarifying filtration (sample concentration 4 g/l). The eluent used is tetrahydrofuran with 0.1% by volume of trifluoroacetic acid. Measurement takes place at 25° C. The preliminary column used is a column type PSS-SDV, 5μ, 10³ Å, ID 8.0 mm×50 mm. Separation is carried out using the columns of type PSS-SDV, 5μ, 10³ Å and also 10⁵ Å and 10⁶ Å each with ID 8.0 mm×300 mm (columns from Polymer Standards Service; detection by means of Shodex R171 differential refractometer). The flow rate is 1.0 ml per minute. Calibration takes place against PMMA standards (polymethyl methacrylate calibration).

Density Determination Via Coat Weight and Layer Thickness (Measurement Method A4):

The specific weight or the density ρ of a coated self-adhesive composition is determined via the ratio of the basis weight to the particular layer thickness:

$$ρ = \frac{m}{V} = \frac{MA}{d} \qquad [ ρ ] = \frac{[ kg ]}{[ {m}^{2} ] \cdot [ m ]} = [ \frac{kg}{{m}^{3}} ]$$

MA=coat weight/basis weight (without liner weight) in [kg/m²]

d=layer thickness (without liner thickness) in [m].

This method gives the gross density.

This density determination is suitable in particular for determining the total density of completed products, including multi-layer products.

Measurement Methods (PSAs in Particular):

180° Peel Adhesion Test (Measurement Method H1):

A strip 20 mm wide of an acrylate PSA applied to polyester as a layer was applied to steel plates which beforehand had been washed twice with acetone and once with isopropanol. The pressure-sensitive adhesive strip was pressed onto the substrate twice with an applied pressure corresponding to a weight of 2 kg. The adhesive tape was then removed from the substrate immediately with a speed of 300 mm/min and at an angle of 180°. All measurements were conducted at room temperature.

The measurement results are reported in N/cm and have been averaged from three measurements. The peel adhesion to polyethylene (PE) was determined analogously.

Holding Power (Measurement Method H2):

A strip of the adhesive tape 13 mm wide and 30 mm long was applied to a smooth steel surface which had been cleaned three times with acetone and once with isopropanol. The bond area was 20 mm×13 mm (length×width), the adhesive tape protruding beyond the test plate at the edge by 10 mm. Subsequently the adhesive tape was pressed onto the steel support four times, with an applied pressure corresponding to a weight of 2 kg. This sample was suspended vertically, with the protruding end of the adhesive tape pointing downwards.

At room temperature, a weight of 1 kg was affixed to the protruding end of the adhesive tape. Measurement was conducted under standard conditions (23° C., 55% humidity) and at 70° C. in a thermal cabinet.

The holding power times measured (times taken for the adhesive tape to detach completely from the substrate; measurement terminated at 10 000 min) are reported in minutes and correspond to the average value from three measurements.

Microshear Test (Measurement Method H3):

This test serves for the accelerated testing of the shear strength of adhesive tapes under temperature load.

Sample Preparation for Microshear Test:

An adhesive tape (length about 50 mm, width 10 mm) cut from the respective sample specimen was adhered to a steel test plate, which had been cleaned with acetone, in such a way that the steel plate protruded beyond the adhesive tape to the right and the left, and that the adhesive tape protruded beyond the test plate by 2 mm at the top edge. The bond area of the sample in terms of height×width=13 mm×10 mm. The bond site was subsequently rolled over six times with a 2 kg steel roller at a speed of 10 m/min. The adhesive tape was reinforced flush with a stable adhesive strip which served as a support for the travel sensor. The sample was suspended vertically by means of the test plate.

Microshear Test:

The sample specimen for measurement was loaded at the bottom end with a weight of 100 g. The test temperature was 40° C., the test duration 30 minutes (15 minutes' loading and 15 minutes' unloading). The shear travel after the predetermined test duration at constant temperature is reported as the result in μm, as both the maximum value [“max”; maximum shear travel as a result of 15-minute loading]; and the minimum value [“min”; shear travel (“residual deflection”) 15 minutes after unloading; on unloading there was a backward movement as a result of relaxation]. Likewise reported is the elastic component in percent [“elast”; elastic fraction=(max−min)×100/max].

Heat-and-Humidity Resistance (Measurement Method H4):

The respective adhesive was coated in a layer thickness of 50 μm onto both sides of an etched PET film 23 μm thick; after 24 hours of storage at room temperature, a test specimen was punched out with dimensions of 25 mm×25 mm.

The test substrate and also an aluminium cube weighing 42.2 g was cleaned with acetone, and, following evaporation of the solvent, the adhesive assembly was first adhered without bubbles to the aluminium cube and subsequently to the test substrate. The bond was loaded with a 5 kg weight for one minute and stored at room temperature for 24 hours. The test substrate was stored at an angle of 90° (i.e. perpendicularly), the top edge of the cube was marked, and this assembly was stored in a conditioning cabinet at 85° C. and 85% relative humidity. After 48 hours the shear travel of the cube was determined, with the travel being reported in cm. If the cube has become detached, the time to failure of the adhesive bond is reported.

Measurement Methods (Three-Layer Constructions in Particular):

90° Peel Adhesion to Steel—Open and Lined Side (Measurement Method V1):

The peel adhesion to steel was determined under test conditions of 23° C.+/−1° C. temperature and 50%+/−5% relative humidity. The specimens were cut to a width of 20 mm and adhered to a steel plate. Prior to the measurement the steel plate was cleaned and conditioned. For this purpose the plate was first wiped down with acetone and then left to stand in the air for 5 minutes to allow the solvent to evaporate. The side of the three-layer assembly facing away from the test substrate was then lined with a 50 μm aluminium foil, thereby preventing the sample from expanding in the course of the measurement. This was followed by the rolling of the test specimen onto the steel substrate. For this purpose the tape was rolled over 5 times back and forth, with a rolling speed of 10 m/min, using a 2 kg roller. Immediately after the rolling-on operation, the steel plate was inserted into a special mount which allows the specimen to be removed at an angle of 90° vertically upwards. The measurement of peel adhesion was made using a Zwick tensile testing machine. When the lined side was applied to the steel plate, the open side of the three-layer assembly was first laminated to the 50 μm aluminium foil, the release material was removed, and the system was adhered to the steel plate, and subjected to analogous rolling-on and measurement.

The results measured on both sides, open and lined, are reported in N/cm and are averaged from three measurements.

Holding Power—Open and Lined Side (Measurement Method V2):

Specimen preparation took place under test conditions of 23° C.+/−1° C. temperature and 50%+/−5% relative humidity. The test specimen was cut to 13 mm and adhered to a steel plate. The bond area was 20 mm×13 mm (length×width). Prior to the measurement, the steel plate was cleaned and conditioned. For this purpose the plate was first wiped down with acetone and then left to stand in the air for 5 minutes to allow the solvent to evaporate. After bonding had taken place, the open side was reinforced with a 50 μm aluminium foil and rolled over back and forth 2 times using a 2 kg roller. Subsequently a belt loop was attached to the protruding end of the three-layer assembly. The whole system was then suspended from a suitable device and subjected to a load of 10 N. The suspension device was such that the weight loads the sample at an angle of 179°+/−1°. This ensured that the three-layer assembly was unable to peel from the bottom edge of the plate. The measured holding power, the time between suspension and dropping of the sample, is reported in minutes and corresponds to the average value from three measurements. To measure the lined side, the open side was first reinforced with the 50 μm aluminium foil, the release material was removed, and adhesion to the test plate took place as described. The measurement was conducted under standard conditions (23° C., 55% relative humidity).

Dynamic Shear Strength (Measurement Method V3):

A square adhesive transfer tape with an edge length of 25 mm was bonded overlappingly between two steel plates and subjected for 1 minute to a pressure of 0.9 kN (force P). After storage for 24 h, the assembly was parted in a Zwick tensile testing machine at 50 mm/min and at 23° C. and 50% relative humidity by pulling the two steel plates apart at an angle of 180°. The maximum force is reported in N/cm².

Commercially Available Chemicals Used:

| Chemical compound | Trade name | Manufacturer | CAS No. |
|---|---|---|---|
| Bis(4-tert-butylcyclohexyl) | Perkadox ® 16 | Akzo Nobel | 15520-11-3 |
| peroxydicarbonate | | | |
| 2,2′-Azobis(2-methylpropionitrile), | Vazo ® 64 | DuPont | 78-67-1 |
| AIBN | | | |
| Terpene-phenolic-based tackifier | Dertophene ® T110 | DRT, France | 73597-48-5 |
| resin (softening point 110° C., | | | |
| hydroxyl value 45-60) | | | |
| (3-Glycidyloxypropyl)trimethoxy- | Dynasylan ® GLYMO | Evonik | 2530-83-8 |
| silane | | | |
| (3-Glycidyloxypropyl)triethoxy- | Dynasylan ® GLYEO | Evonik | 2602-34-8 |
| silane | | | |
| (3-Glycidyloxypropyl)methyldiethoxy- | KBE-402 | Shinetsu | 2897-60-1 |
| silane | | Silicone, Japan | |
| [2-(3,4-Epoxycyclohexyl)ethyl]- | — | Sigma-Aldrich | 3388-04-3 |
| trimethoxysilane | | | |
| Triethoxy[3-[(3-ethyl-3-oxetanyl)- | Aron Oxetane OXT-610 | Toagosei Co., | 220520-33-2 |
| methoxy]propyl]silane | | Ltd., Japan | |
| 3-Aminopropyltriethoxysilane | Dynasylan ® AMEO | Evonik | 919-30-2 |
| Pentaerythritol tetraglycidyl ether | D.E.R. ™ 749 | Dow Chem | 3126-63-4 |
| | | Corp., USA | |
| Isophoronediamine | Vestamin ® IPD | Evonik | 2855-13-2 |
| 3,4-Epoxycyclohexylmethyl 3,4- | Uvacure ® 1500 | Cytec Industries | 2386-87-0 |
| epoxycyclohexanecarboxylate | | Inc. | |
| Resorcinol bis(diphenyl | Reofos ® RDP | Chemtura | 57583-54-7 |
| phosphate) | | | |
| Thermoplastic hollow microbeads | Expancel ® 092 | Akzo Nobel | |
| (particle size 10-17 μm; density max. | DU 40 | | |
| 0.017 g/cm³; expansion temperature | | | |
| 127-139° C. [start]; | | | |
| 164-184° C. [max. Exp.]) | | | |

all specification figures at 20° C.;

### Examples

Preparation of Starting Polymers P1 to P3

Described below is the preparation of the starting polymers. The polymers investigated were prepared conventionally via free radical polymerization in solution.

Base Polymer P1

A 300 L reactor conventional for radical polymerizations was charged with 30 kg of EHA, 67 kg of BA, 3 kg of acrylic acid and 66 kg of acetone/isopropanol (96:4). After nitrogen gas has been passed through the reactor for 45 minutes with stirring, the reactor was heated to 58° C. and 50 g of Vazo® 67 were added. Subsequently the external heating bath was heated to 75° C. and the reaction was carried out constantly at this external temperature. After 1 h a further 50 g of Vazo® 67 were added, and after 4 h the batch was diluted with 20 kg of acetone/isopropanol mixture (96:4). After 5 h and again after 7 h, initiation was repeated with 150 g of Perkadox® 16 each time, and dilution took place with 23 kg of acetone/isopropanol mixture (96:4) each time. After a reaction time of 24 h, the reaction was discontinued and the batch was cooled to room temperature. The polyacrylate has a K value of 75.1, a solids content of 50.2% and average molecular weights as measured by GPC of Mₙ=91 900 g/mol and M_{w}=1 480 000 g/mol.

Base Polymer P2

A 300 L reactor conventional for radical polymerizations was charged with 11.0 kg of acrylic acid, 27.0 kg of butyl acrylate (BA), 62.0 kg of 2-propylheptyl acrylate and 72.4 kg of acetone/isopropanol (94:6). After nitrogen gas had been passed through the reactor for 45 minutes with stirring, the reactor was heated to 58° C. and 50 g of Vazo® 67 were added. Subsequently the external heating bath was heated to 75° C. and the reaction was carried out constantly at this external temperature. After a reaction time of 1 h a further 50 g of Vazo® 67 were added. The batch was diluted after 3 h with 20 kg of acetone/isopropanol (94:6) and after 6 h with 10.0 kg of acetone/isopropanol (94:6). For reduction of the residual initiators, 0.15 kg portions of Perkadox® 16 were added after 5.5 h and again after 7 h. After a reaction time of 24 h, the reaction was discontinued and the batch was cooled to room temperature. The polyacrylate has a K value of 50.3, a solids content of 50.1% and average molecular weights as measured by GPC of Mₙ=25 000 g/mol and M_{w}=1 010 000 g/mol.

In examples B8-B10 and also VB11 and VB12, the base polymer was also used as outer PSA layer for three-layer foamed PSA tapes. For this purpose the polyacrylate was blended in solution with 0.2 wt % of the crosslinker Uvacure® 1500, diluted to a solids content of 30% with acetone and then coated onto a siliconized release film (50 μm polyester) or onto an etched PET film 23 μm thick (coating speed 2.5 m/min, drying tunnel 15 m, temperatures zone 1: 40° C., zone 2: 70° C., zone 3: 95° C., zone 4: 105° C.). The coat weight was 50 g/m².

Base Polymer P3

A 300 L reactor conventional for radical polymerizations was charged with 7.0 kg of acrylic acid, 25.0 kg of methyl acrylate, 68.0 kg of 2-ethylhexyl acrylate and 66.0 kg of acetone/isopropanol (96:4). After nitrogen gas had been passed through the reactor for 45 minutes with stirring, the reactor was heated to 58° C. and 50 g of Vazo® 67 were added. Subsequently the external heating bath was heated to 75° C. and the reaction was carried out constantly at this external temperature. After a reaction time of 1 h a further 50 g of Vazo® 67 were added. The batch was diluted after 3 h with 25 kg of acetone/isopropanol (96:4) and after 6 h with 10.0 kg of acetone/isopropanol (96:4). For reduction of the residual initiators, 0.15 kg portions of Perkadox® 16 were added after 5.5 h and again after 7 h. After a reaction time of 24 h, the reaction was discontinued and the batch was cooled to room temperature. The polyacrylate has a K value of 51.0, a solids content of 50.2% and average molecular weights as measured by GPC of Mₙ=74 700 g/mol and M_{w}=657 000 g/mol.

Production of the PSA Examples and Viscoelastic Foamed Carrier Examples B1-B10 and Also of Comparative Examples VB11 and VB12

Process 1: Concentration/Preparation of the Hotmelt PSAs:

The base polymer P was very largely freed from the solvent by means of a single-screw extruder (concentrating extruder, Berstorff GmbH, Germany) (residual solvent content ≦0.3% by weight). The parameters were as follows for the concentration of the base polymer: the screw speed was 150 rpm, the motor current 15 A, and a throughput of 58.0 kg liquid/h was realized. For concentration, a vacuum was applied at three different domes. The reduced pressures were, respectively, between 20 mbar and 300 mbar. The exit temperature of the concentrated hotmelt was approximately 115° C. The solids content after this concentration step was 99.8%.

Process 2: Production of the Inventive Adhesive Tapes Blending with the Crosslinker-Accelerator System for Thermal Crosslinking, and Coating:

The processing and optional foaming took place in an experimental line corresponding to the representation in FIG. 2.

The base polymer P was melted according to Process 1 in a feeder extruder 1 which conveyed it as a polymer melt via a heatable hose 11 into a planetary roller extruder 2 (PRE) (more particularly a PRE having four modules T1, T2, T3, T4 heatable independently of one another was used). Via the metering opening 22 it was possible to supply additional additives or fillers such as colour pastes, for example. The crosslinker was added at point 23. All of the components were mixed to form a homogeneous polymer melt.

By means of a melt pump 24a, the polymer melt was transferred into a twin-screw extruder 3 (feed position 33). At position 34, the accelerator component was added. The mixture as a whole was subsequently freed from all gas inclusions in a vacuum dome V under a pressure of 175 mbar (for criterion of gas-free state, see above). Following the vacuum zone, a blister B was located on the screw, and allowed the pressure to be built up in the following segment S. In the case of foamed products, a pressure of greater than 8 bar was built up in the segment S between blister B and melt pump 37a, by appropriately controlling the extruder speed and the melt pump 37a, a microballoon mixture (microballoons embedded in the dispersing assistant Reofos® RDP) was added at metering point 35 and was incorporated homogeneously into the preliminary mixture by means of a mixing element. The resulting melt mixture was transferred to a die 5.

Following departure from the die 5, in other words after a drop in pressure, the optionally incorporated microballoons underwent expansion, and the drop in pressure resulted in a low-shear cooling of the polymer composition and gave a foamed PSA.

In the case of a single-sided or double-sided adhesive tape, the polymer was coated, according to product construction, onto a film, a nonwoven web or a foam. The belt speed on travel through the coating line was 100 m/min.

In the case of the adhesive transfer tape or of the viscoelastic carrier layers for multi-layer adhesive tapes, both the unfoamed and the foamed polymer were subsequently coated between two release materials, which could be used again after being removed (process liners), and were shaped to a web form using a roll calender 4.

In order to improve the anchoring of the PSA P2 (coated from solution and crosslinked with Uvacure 1500) from examples B8-B10 and also VB11 and VB12 to the shaped polyacrylate (foam), not only the PSAs but also the polymer or polymer foam were pretreated by corona (corona unit from Vitaphone, Denmark, 70 W·min/m²). Following the production of the three-layer assembly, this treatment resulted in improved chemical attachment to the polyacrylate (foam) carrier layer.

The belt speed on travel through the coating line was 30 m/min.

Following departure from the roll nip, an anti-adhesive carrier was removed, where necessary, and the completed three-layer product was wound up together with the remaining, second anti-adhesive carrier.

Examples B1 to B10, and comparative examples VB11 to VB13, listed in table 1, were produced according to processes 1 and 2. In the case of examples B1 to B7 and VB11 to VB13, double-sided PSA tapes were produced, with the PSAs being coated onto an etched PET film 23 μm thick. Examples B8 and B9 are foamed adhesive transfer tapes, and examples B10 and VB14 are foamed viscoelastic carriers for adhesive assembly tapes, which were additionally coated on both sides with a PSA.

TABLE 1
Examples B1-B10 and comparative examples VB11-VB14-Formulas

| | | | | Resin | | Layer |
|---|---|---|---|---|---|---|
| | | Crosslinker | Accelerator | DT110 | Microballoons | thickness |
| Ex. | Polymer | [wt %]^{a)} | [wt %]^{a)} | [wt %] | [wt %] | [μm]^{c)} |
| B1 | P1 | GLYEO; 0.14 | AMEO; 0.50 | 32 | — | 100 |
| B2 | P1 | GLYEO; 0.20 | AMEO: 0.40 | 32 | — | 100 |
| B3 | P1 | GLYMO; 0.13 | AMEO; 0.50 | 32 | — | 100 |
| B4 | P1 | ^{b)}; 0.20 | AMEO; 0.50 | 32 | — | 100 |
| B5 | P1 | OXT-610; | AMEO; 0.40 | 32 | — | 100 |
| | | 0.18 | | | | |
| B6 | P1 | OXT-610; | AMEO; 0.80 | 32 | — | 100 |
| | | 0.18 | | | | |
| B7 | P2 | GLYEO; 0.10 | AMEO; 0.30 | — | — | 100 |
| B8 | P3 | GLYEO; 0.20 | AMEO; 0.30 | — | 2 | 1000 |
| B9 | P3 | GLYEO; 0.30 | AMEO; 0.30 | — | 2 | 1000 |
| B10 | P1 | GLYEO; 0.25 | AMEO; 0.30 | — | 1.5 | 900 |
| VB11 | P1 | GLYEO; 0.14 | — | 32 | — | 100 |
| VB12 | P1 | — | AMEO; 0.50 | 32 | — | 100 |
| VB13 | P1 | D.E.R. 749, | Vestamin IPD, | 32 | — | 100 |
| | | 0.12 | 0.80 | | | |
| VB14 | P1 | D.E.R. 749, | Vestamin IPO, | — | 1.5 | 900 |
| | | 0.14 | 0.14 | | | |

^{a)}The concentration FIGURE for the crosslinker and for the accelerator is based only on the base polymer. The components were added additively to the polymer and not taken into account when calculating quantities of resin and, where appropriate, of microballoons.
^{b)}[2-(3,4-Epoxycyclohexyl)ethyl]trimethoxysilane
^{c)}The specimens 100 μm thick were coated onto both sides of an etched PET film 23 μm thick.

The density of the foamed specimens B8-B10 and also VB14 is 749 kg/m³ and was determined by measurement method A4.

The crosslinking reaction rate was determined by measuring the elastic component (measurement method H3), using the assumption that crosslinking is at an end as soon as there was no longer any significant change apparent in the measurement results.

TABLE 2
Examples B1-B10 and comparative examples VB11-VB14-
Time profile of the elastic component in % for determining the
kinetics of the crosslinking reaction

| Ex. | 7 d | 10 d | 14 d | 28 d | 42 d | 66 d |
|---|---|---|---|---|---|---|
| B1 | 40 | 58 | 62 | 66 | 65 | 66 |
| B2 | 40 | 57 | 68 | 70 | 69 | 70 |
| B3 | 45 | 61 | 65 | 66 | 67 | 66 |
| B4 | 38 | 58 | 60 | 59 | 60 | 60 |
| B5 | 20 | 58 | 62 | 63 | 61 | 62 |
| B6 | 40 | 61 | 61 | 63 | 62 | 61 |
| B7 | 56 | 78 | 85 | 86 | 85 | 85 |
| B8 | 42 | 56 | 60 | 61 | 60 | 62 |
| B9 | 49 | 66 | 72 | 72 | 71 | 73 |
| B10 | 22 | 36 | 58 | 65 | 65 | 66 |
| VB11 | n.d. | n.d. | n.d. | n.d. | 10 | 18 |
| VB12 | n.d. | n.d. | n.d. | n.d. | n.d. | n.d. |
| VB13 | n.d. | n.d. | 2 | 33 | 65 | 65 |
| VB14 | n.d. | n.d. | 5 | 42 | 64 | 66 |

n.d.: The elastic component could not be determined, since the specimens dropped off during the time indicated in measurement method H3.

The comparison of comparative example VB13 with examples B1-B6 shows that all of the crosslinker-accelerator combinations give a comparable elastic component. In the case of VB13, however, a measurable elastic component is obtained only after 14 days, whereas the crosslinking of the inventive examples is concluded completely after 14 days and in some cases after just 10 days. A similar result is obtained when comparing B10 with VB14. The examples with an increased acrylic acid fraction (base polymers P2 and P3) also show that the crosslinker-accelerator systems of the invention still have good extruder processability and that the crosslinking is concluded after just a short time. It is apparent, moreover, that the use of methoxysilane-based (B3) rather than ethoxysilane-based (B1 and B2) crosslinkers also leads to a further increase in reaction rate. Where no accelerator is used (VB11), it is found that the crosslinking rate is too slow. In VB12 only the accelerator is used, but no crosslinker, leading to a completely non-crosslinked polymer. On the basis of these results, VB11 and VB12 were not evaluated further.

Technical Adhesive Evaluation of the Double-Sided PSA Tape Examples B1-B7 and VB13

From the examples below it is evident that not only the inventive crosslinkers but also the crosslinker-accelerator system of the comparative example lead to similar technical adhesive properties. However, the inventive examples exhibit not only much faster crosslinking but also a significantly better heat-and-humidity resistance on a variety of materials.

TABLE 3
Examples B1-B7 and comparative example VB13-Technical adhesive
data of the PSAs

| | Peel | Peel | | | | Elast. | Heat/ | Heat/ |
|---|---|---|---|---|---|---|---|---|
| | adhesion | adhesion | HP, 10N, | HP, 10N, | MST | com- | humidity | humidity |
| | steel | PE | 23° C. | 70° C. | max | ponent | PC | glass |
| Ex. | [N/cm] | [N/cm] | [min] | [min] | [μm] | [%] | [cm] | [cm] |
| B1 | 10.6 | 4.5 | 5 400 | 980 | 360 | 66 | 0.1 | 0.1 |
| B2 | 9.9 | 4.2 | >10 000 | 1 800 | 220 | 70 | 0.1 | 0.1 |
| B3 | 10.5 | 4.5 | 5 600 | 1 000 | 355 | 66 | <0.1 | <0.1 |
| B4 | 10.6 | 5.0 | >10 000 | 2 200 | 240 | 60 | 0.1 | 0.2 |
| B5 | 10.2 | 4.4 | 6 000 | 800 | 380 | 62 | 0.2 | 0.2 |
| B6 | 10.3 | 4.8 | 6 400 | 900 | 350 | 61 | 0.1 | 0.1 |
| B7 | 10.0 | 1.2 | >10 000 | >10 000 | 180 | 85 | <0.1 | <0.1 |
| VB13 | 11.0 | 4.8 | 9 150 | 1 200 | 350 | 65 | n.b. | n.b. |
| | | | | | | | (24 h) | (3 h) |

Peel adhesion steel and PE = Measurement method H1,
HP = Holding powers 23° and 70° C. = Measurement method H2,
MST = Microshear test = Measurement method H3,
Elast. component = Elastic component,
Heat/humidity = Measurement method H4,
n.b. = Failed

It is further evident that an increase in the crosslinking concentration results in greater cohesion (comparison of examples B1 and B2) and that increasing the amount of accelerator while leaving the crosslinker concentration the same results in the same adhesive properties but in a significant acceleration to crosslinking (comparison of examples B5 and B6).

Technical Adhesive Evaluation of Viscoelastic Carriers B8 and B9 and of Three-Layer Constructions B10 and VB14

In these examples as well it is evident that not only the inventive crosslinkers but also the crosslinker-accelerator system of the comparative example lead to similar technical adhesive properties, but that the inventive examples exhibit not only much quicker crosslinking but also significantly better heat-and-humidity resistance on various materials.

TABLE 4
Examples B8-B10 and comparative example VB12-Technical adhesive data
of the viscoelastic carriers and three-layer constructions

| | | Peel | Peel | | HP, | Heat/ | Heat/ | |
|---|---|---|---|---|---|---|---|---|
| | Outer | adhesion | adhesion | HP, 10N, | 10N, | humidity | humidity | Dyn. |
| | PSA | steel | PE | 23° C. | 70° C. | PC | glass | shear |
| Ex. | layer | [N/cm] | [N/cm] | [min] | [min] | [cm] | [cm] | [N/cm²] |
| B1 | — | 45 f.s. | 18 | >10 000 | 1 200 | 0.1 | 0.1 | 120 |
| B2 | — | 45 f.s. | 16 | >10 000 | 2 400 | 0.1 | 0.1 | 130 |
| B3 | P2^{a)} | 50 f.s. | 28 | >10 000 | 6 800 | <0.1 | <0.1 | 90 |
| VB14 | P2^{a)} | 50 f.s. | 29 | >10 000 | 6 900 | 0.3 | 1.5 | 100 |

^{a)}Crosslinked with 0.2% Uvacure 1500 and coated from solution
Peel adhesion steel and PE = Measurement method V1,
f.s. = Foam split,
HP = Holding powers 23° and 70° C. = Measurement method V2,
Heat/humidity = Measurement method H4,
Dynamic shear strength = Measurement method V3

1. Composition for preparing a pressure-sensitive adhesive, comprising
a) at least one crosslinkable poly(meth)acrylate;
b) at least one organosilane conforming to the formula (1)
R¹—Si(OR²)ₙR³ₘ (1),
in which R¹ is a radical containing a cyclic ether function,
the radicals R² independently of one another are each an alkyl or acyl radical,
R³ is a hydroxyl group or an alkyl radical,
n is 2 or 3 and m is the number resulting from 3-n; and
c) at least one substance accelerating the reaction of the crosslinkable poly(meth)acrylate with the cyclic ether functions.

2. Composition according to claim 1, wherein the poly(meth)acrylate contains hydroxyl and/or carboxylic acid groups.

3. Composition according to claim 1, wherein: R¹ contains an epoxide group or oxetane group.

4. Composition according to claim 1, wherein: R¹ contains a glycidyloxy, 3-oxetanylmethoxy or epoxycyclohexyl group.

5. Composition according to claim 1, wherein: the radicals R² independently of one another are each an alkyl group.

6. Composition according to claim 1, wherein: the radicals R² independently of one another are each a methyl or ethyl group.

7. Composition according to claim 1, wherein R³ is a methyl group.

8. Composition according to claim 1, wherein the composition comprises organosilanes conforming to the formula (1) at in total 0.05 to 0.5 wt %, based on the total weight of the composition.

9. Composition according to claim 1, wherein the substance accelerating the reaction of the crosslinkable poly(meth)acrylate with the cyclic ether functions comprises at least one basic function.

10. Composition according to claim 1, wherein the substance accelerating the reaction of the crosslinkable poly(meth)acrylate with the cyclic ether functions is an organosilane containing at least one amino group and at least one alkoxy or acyloxy group.

11. Composition according to claim 1, wherein the composition comprises substances accelerating the reaction of the crosslinkable poly(meth)acrylate with the cyclic ether functions at in total 0.05 to 1.0 wt %, based on the total weight of the composition.

12. Pressure-sensitive adhesive composition formed from a composition according to claim 1.
